(19) United States
(12) Patent Application Publication
(10) Pub. No.: US 2019/0114155 A1
(43) Pub. Date: Apr. 18, 2019

(54) SYSTEM CONFIGURED FROM NON-DEVELOPER-ORIENTED APPLICATION PLATFORM

(71) Applicants: FREECORE, INC., Seongnam-si (KR); Sung Pyo HONG, Yongin-si (KR)

(72) Inventor: Sung Pyo Hong, Yongin-si (KR)

(73) Assignees: FREECORE, INC., Seongnam-si (KR); Sung Pyo Hong, Yongin-si (KR)

(21) Appl. No.: 16/216,292

(22) Filed: Dec. 11, 2018

Related U.S. Application Data
(63) Continuation of application No. PCT/KR2017/003381, filed on Mar. 29, 2017.

(30) Foreign Application Priority Data
Jun. 13, 2016 (KR) 10-2016-0072997

(51) Int. Cl. G06F 8/38; G06F 8/76

(52) U.S. Cl. CPC G06F 8/38; G06F 8/76

(57) ABSTRACT

A system constituting an application platform, comprising: an application content manager that: causes developers to register filters in a filter store; enables a user who uses an AppWriter to use the registered filters; causes the AppWriter to provide a method for configuring a content process pipeline without coding; automatically processes the content while periodically executing the configured pipeline; and causes a general-purpose repository to store different kinds of contents, and an application generator that: causes a resource store to provide resources necessary for app-writing and operation; causes the AppWriter to provide a WYSIWYG-type UI capable of producing an application that provides a desired function and UI without a prior knowledge for creation of the application; causes an application renderer to output an application source to an UI adapted to the platform; and causes the content pipeline to provide a repository that stores the created content and operate repositories.

### BACKGROUND

### Technical Field

The present invention relates to a non-developer-oriented application (app) platform, and more particularly, to a system configured as a non-developer-oriented application platform wherein the non-developer-oriented application (app) platform provides an app. DIY that is a method in which field experts without IT knowledge can personally fabricate their own work process-related improvement ideas by means of the application (app) without coding, and provides a method in which various constituent technologies provided through a resource store by ICT experts are arranged by means of a mind map method established as a representation method for arranging ideas and are fabricated as one application (app), wherein a mind-map type AppWriter that anyone can easily learn performs an IDE role in which general users without app-related development experience can easily represent their own ideas by means of an application (app) and which is used by developers when developing apps, and provides instantaneity and quickness with which content represented as a mind map can be instantly fabricated as an app and operated, wherein an app written by the non-developer-oriented application (app) platform is driven on a flexible cloud infrastructure, and thus can be extended to an infrastructure easily enabling a large-scale service, wherein a project scale is downsized to a widget or a filter as a module of a very small unit so that the development period and cost can be reduced to decrease a failure rate of a current project, and wherein an app development company can implement a new profit model through a theme store, a widget store, and a filter store that are resources capable of selling a module developed in a component-based development scheme.

### Description of Related Art

Korean Patent Laid-Open Publication No. 10-2008-0046801 (laid-open on May 28, 2008) discloses that a communication method between a mobile terminal and an Internet website through a wireless Internet is currently being developed increasingly. Along with the advancement of such a wireless communication network, the amount and kind of content provided to the mobile terminal is increasing exponentially.

However, the content provided the mobile terminal entails a problem in that since it is relatively stereotyped compared to content used by a computer and its diversity is decreased, the content does not satisfy a user's needs. In addition, the content provided to the mobile terminal is created according to the standards defined by mobile terminal manufacture companies or telecommunication companies, making it difficult for a user to be provided with content according to a user's individual taste.

In the meantime, in a developer-oriented application (app) ecosystem, only a service targeting a market having a scale enabling the creation of profits is generally developed, and the improvement idea of a work process is created through the mobile terminal along with rapidly increasing spread of smartphones and familiarity with UX applied with mobility. However, a lot of ideas are discarded which do not have marketability capable of achieving a market economic system of a scale enough to implement a relevant idea. Furthermore, although an effect can be definitely attained through any idea improvement in a field where a user who has found at least a relevant idea works, the idea is discarded.

Further, the development of an application (app) requires the aid of much development and operation manpower such as a planner, a developer, a designer, a publisher, and an infrastructure operator, and thus much cost and time is spent for development of the application (app).

An survey “The Project and Portfolio Management Landscape” of an Innotas report revealed that the failure rate of the IT project in an existing app development system rather increased compared to that in 2014. Among 126 IT experts who participated in a response program from January to March 2015, the ratio of experts who experienced an unsuccessful project reached up to 55%.

In such a difficult environment, in order to effectively operate an application (app) service despite the success of the development of the application (app), an additional development of “back-office” and an app service operation experience are needed.

Therefore, there is an urgent need for the development of a system configured as a non-developer-oriented application platform wherein the non-developer-oriented application (app) platform provides a method in which various constituent technologies provided through a resource store by ICT experts are arranged by means of a mind map method established as a representation method for arranging ideas and are fabricated as one application (app), and wherein a mind-map type AppWriter that anyone can easily learn performs an IDE role in which general users without app-related development experience can easily represent their own ideas by means of an application (app) and which is used by developers when developing apps, and provides instantaneity and quickness with which content represented as a mind map can be instantly fabricated as an app and operated.

### SUMMARY

Accordingly, a system according to one or more embodiments of the present invention is configured as a non-developer-oriented application platform wherein the non-developer-oriented application (app) platform provides an app. DIY that is a method in which field experts without IT knowledge can personally fabricate their own work process-related improvement ideas by means of the application (app) without coding.

A system according to one or more embodiments of the present invention is configured as a non-developer-oriented application platform wherein the non-developer-oriented application (app) platform provides a method in which various constituent technologies provided through a resource store by ICT experts are arranged by means of a mind map method established as a representation method for arranging ideas and are fabricated as one application (app).

A system according to one or more embodiments of the present invention is configured as a non-developer-oriented application platform wherein a mind-map type AppWriter that anyone can easily learn performs an IDE role in which general users without app-related development experience can easily represent their own ideas by means of an application (app) and which is used by developers when developing apps.

A system according to one or more embodiments of the present invention is configured as a non-developer-oriented application platform wherein a mind-map type AppWriter that anyone can easily learn provides instantaneity and quickness with which content represented as a mind map can be instantly fabricated as an app and operated.

A system according to one or more embodiments of the present invention is configured as a non-developer-oriented application platform wherein an app written by the non-developer-oriented application (app) platform is driven on a flexible cloud infrastructure, and thus can be extended to an infrastructure easily enabling a large-scale service.

A system according to one or more embodiments of the present invention is configured as a non-developer-oriented application platform wherein a project scale is downsized to a widget or a filter as a module of a very small unit so that the development period and cost can be reduced to decrease a failure rate of a current project.

A system according to one or more embodiments of the present invention is configured as a non-developer-oriented application platform wherein an app development company can implement a new profit model through a theme store, a widget store, and a filter store that are resources capable of selling a module developed in a component-based development scheme.

In accordance with one or more embodiments of the present invention, there is provided a system configured as a non-developer-oriented application platform, including: an app's content management unit having a function in which developers register filters in a filter store that deals in a source filter, a process filter, and a storage filter, which process content, a function in which a user who uses a AppWriter uses the registered filters, a function in which the AppWriter provides a method in which a non-developer can configure a content process pipeline without coding, and also provides an N-screen type UI that connects and configures the filters registered in the filter store in the order of necessary processes, a function in which the content pipeline enables a dynamic configuration of a series of procedures of fetching, processing, and storing app content, a function in which content is automatically processed while periodically executing the configured pipeline, and a function in which a general-purpose repository stores various kinds of contents and serves as a content source and repository, and the stored content is used by an app representation unit; an app generation unit having a function in which a resource store provides various resources necessary for app-writing and operation on a pay-free basis depending on a policy of a resource manufacturer, a function in which the AppWriter provides a WYSIWYG-type UI capable of producing an app that provides a desired function and UI without a prior knowledge for creation of the app, a function in which an app renderer outputs an app source to an UI adapted to a platform, a function in which the content pipeline provides a repository that stores the content created by an app and operates a plurality of repositories as many as necessary; an app representation unit having a function in which the general-purpose repository configures and manages various repositories capable of storing various kinds of contents, generates and use a repository as many as required by an app, and connects one repository to a number of apps in use, a function in which the app renderer generates an UI to fit the property of a platform called to a region that executes an app source generated by the app generation unit 200 and executed by an app runner, and a function in which a cross-platform app runner provides an API implemented to fit the property of a relevant platform to a cross-platform-based app execution region enabling One Source Multi Use (OSMU), and also provides a runner based on WEB, Android, and iOS; and an app resource management unit 400 having a function in which a filter store provides the source filter, the process filter, and the storage filter that process content, wherein source filter, the process filter, and the storage filter are developed by a developer and are provided to a user of the AppWriter on a pay-free basis depending on a policy of a resource manufacturer, a function in which a widget store provides various widgets that use contents or Open API stored in the app content management unit in such that the widgets are provided to the user of the AppWriter and are fabricated as one app, and the filters are provided on a pay-free basis depending on a policy of the resource manufacturer, and also provides a widget manager module and a user module at the time of development of the widget, a function in which a theme store provides a theme for provision of an UI fitting a platform by an app such that the theme is provided for the exclusive use of Web, Android, and iOS or can be developed in a responsive format and provided on a pay-free basis depending on a policy of the resource manufacturer, and a function in which an environment is provided where a non-developer can produce and operate an app using the resource provided by the AppWriter.

In one or more embodiments of the present invention, the app configured in the AppWriter 500 constituting the app generation unit 200 may be generated as the app source 222 of a JSON format that the app renderer 240 can recognize, and may be provided with a sub module registered by developers through stores to produce apps providing various functions.

In one or more embodiments of the present invention, the app production in the app generation unit may include: a process of registering a resource in the resource store consisting of the theme store, the widget store, and the filter store; a process of setting a special node using splash, app meta information, theme, header, footer, and menu in order for the AppWriter to generate and edit an app in a mind map type, and setting a content node through presentation layer setting and business logic setting; a process of generating the app source through app preview and source generation; and a process of executing an app using Web, Android, and iOS.

In one or more embodiments of the present invention, the node setting during the drive of the mind map type AppWriter in the app generation unit may include: a new node adding process of selecting a parent node in consideration of the dependency of a node; a node role setting process of setting each node as a special node or a content node of meta information, theme information, header region, footer region, and menu region, and then setting a module to be applied with respect to the content node, a module setting process in which the content node is generated as many as necessary and is implemented as one page which is configured by a combination of multiple widgets, and a module is set which fits a role designating a method of storing content in a relevant repository by setting the content pipeline when operatively cooperating with the repository, and a parameter setting process in which a widget development company supplies a user widget used by an app and a manager widget used by the AppWriter, a selected widget is downloaded from a store through the module setting process, the manager widget is called and activated in the node setting and generates, as a user select value, a parameter necessary during the drive of the user widget through a setting screen provided by itself.

In one or more embodiments of the present invention, the setting of the content pipeline 230 in the app generation unit may include: a process of entering the setting of a pipeline of a content node that can be designated only for the content node, a process of acquiring content from a service supporting the Open API, or fetching the acquired content through the RSS of a blog, a process of designating a repository for storing content by designating an existing general-purpose content repository or a new repository, a process of designating a general-purpose content repository to be used as a repository if content to be used as a general-purpose content bulletin board is not provided externally, a process in which a manufacturing company that developed a filter supplies the filter to AppWriter users through the filter store, and provides information on a filter that can be used in a filter repository selecting a pay-free scheme depending on a policy of the manufacturer at the time of supply of the filter, and a process in which a content crawler as a service externally inquiring content is operated in a predetermined cycle and a content pipeline generated by adding a new content is driven by the crawler in the predetermined cycle.

In one or more embodiments of the present invention, the content pipeline may be configured in the order of the source filter, the process filter, and the storage filter.

In one or more embodiments of the present invention, the generation of the app source in the app generation unit may include: a process in which each node configured in a mind map type activates a relevant module while setting itself in the vertical dependency relationship and is represented as a format, the app source generated for the content node is used by the content pipeline crawler and the app renderer, the setting of each node is converted into the app source of a JSON/XML format through a search from a mind map to a child node, and the generated app source is transferred to the app renderer which turn renders an UI that fits the property of a called platform.

As described above, the system configured as a non-developer-oriented application platform according to one or more embodiments of the present invention has the following effects.

First, the non-developer-oriented application (app) platform provides an app. DIY that is a method in which field experts without IT knowledge can personally fabricate their own work process-related improvement ideas by means of the application (app) without coding.

Second, the non-developer-oriented application (app) platform provides a method in which various constituent technologies provided through a resource store by ICT experts are arranged by means of a mind map method established as a representation method for arranging ideas and are fabricated as one application (app).

Third, a mind-map type AppWriter that anyone can easily learn performs an IDE role in which general users without app-related development experience can easily represent their own ideas by means of an application (app) and which is used by developers when developing apps.

Fourth, a mind-map type AppWriter that anyone can easily learn provides instantaneity and quickness with which content represented as a mind map can be instantly fabricated as an app and operated.

Fifth, an app written by the non-developer-oriented application (app) platform is driven on a flexible cloud infrastructure, and thus can be extended to an infrastructure easily enabling a large-scale service.

Sixth, a project scale is downsized to a widget or a filter as a module of a very small unit so that the development period and cost can be reduced to decrease a failure rate of a current project.

Seventh, an app development company can implement a new profit model through a theme store, a widget store, and a filter store that are resources capable of selling a module developed in a component-based development scheme.

### BRIEF DESCRIPTION OF THE DRAWINGS

The above and other features and advantages of the present invention will be apparent from the following detailed description of the embodiments of the invention in conjunction with the accompanying drawings, in which:

FIG. 1 is a view showing a system configured as a non-developer-oriented application platform according to one or more embodiments of the present invention;

FIG. 2 is a view specifically showing a system configured as a non-developer-oriented application platform according to one or more embodiments of the present invention;

FIG. 3 is a view showing a driving system of an AppWriter according to one or more embodiments of the present invention;

FIG. 4 is a view showing a configuration of a content pipeline according to one or more embodiments of the present invention;

FIG. 5 is a view showing a JSON-format app source that is set at the time of generation of an app source according to one or more embodiments of the present invention;

FIG. 6 is a view showing a theme store of a resource store according to one or more embodiments of the present invention;

FIG. 7 is a view showing a widget store of a resource store according to one or more embodiments of the present invention; and

FIG. 8 is a view showing a filter store of a resource store according to one or more embodiments of the present invention.

FIG. 9 shows a computing system in accordance with one or more embodiments of the invention.

### DETAILED DESCRIPTION OF EMBODIMENTS

Reference will be now made in detail to embodiments of the present invention with reference to the attached drawings. In the following description, the detailed description on related known function and constructions unnecessarily obscuring the subject matter of the present invention will be avoided hereinafter. Also, the terms used herein are defined in consideration of the function of one or more embodiments of the present invention, which may vary according to an intention of a user or an operator or according to custom. Thus, the definition of such terms should be made based on the contents throughout the specification disclosing a system configured as a non-developer-oriented application platform according to one or more embodiments of the present invention.

Hereinafter, a system configured as a non-developer-oriented application platform according to one or more embodiments of the present invention will be described in detail with reference to the accompanying drawings.

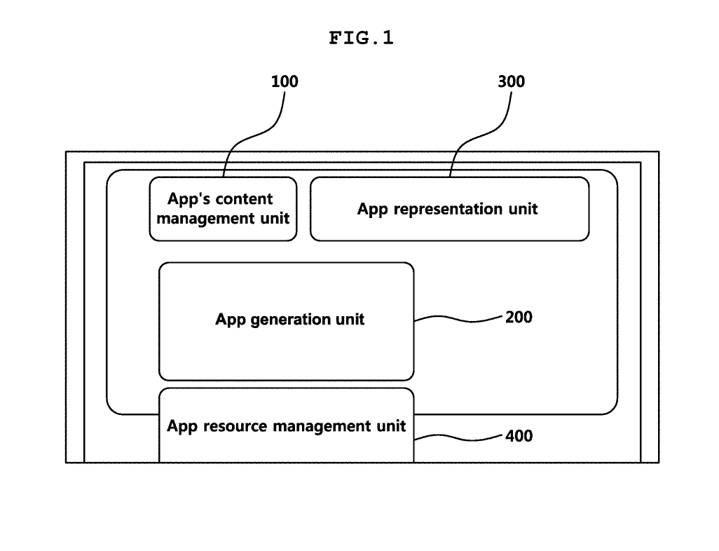

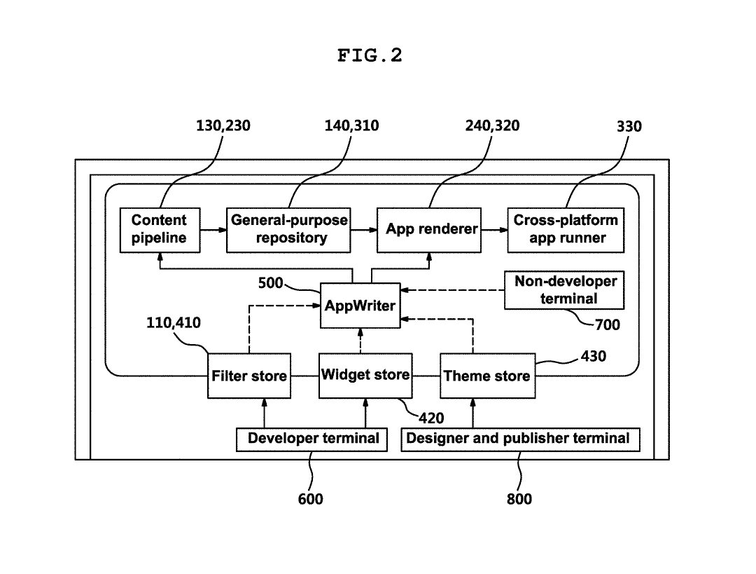

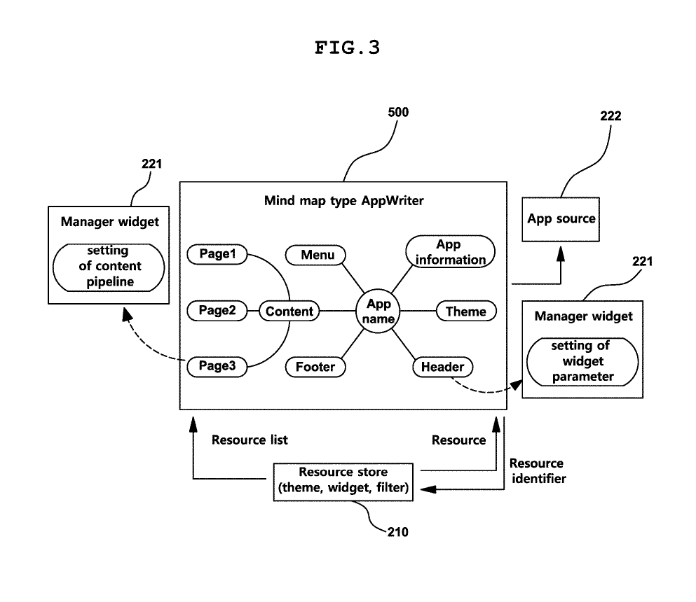

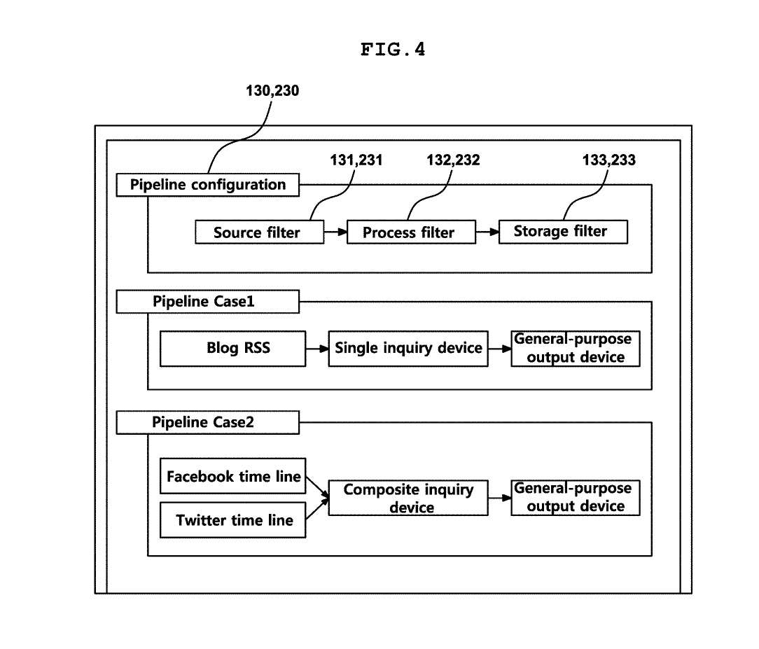

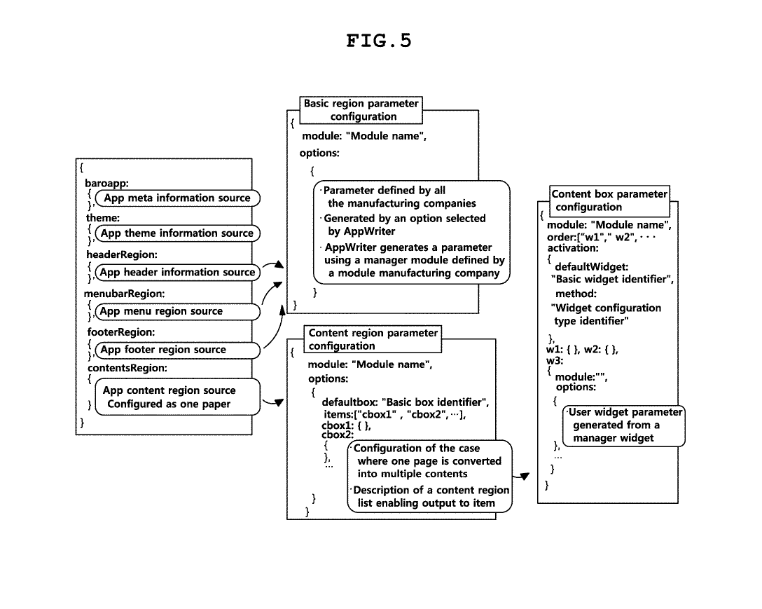

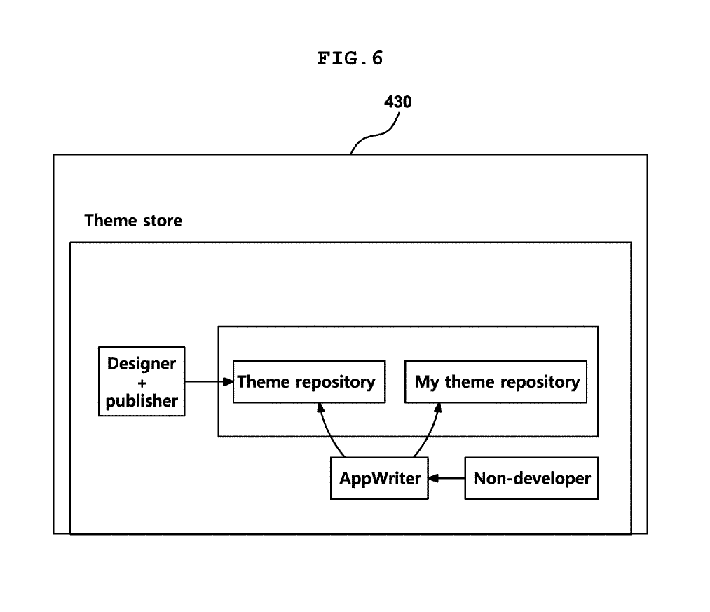

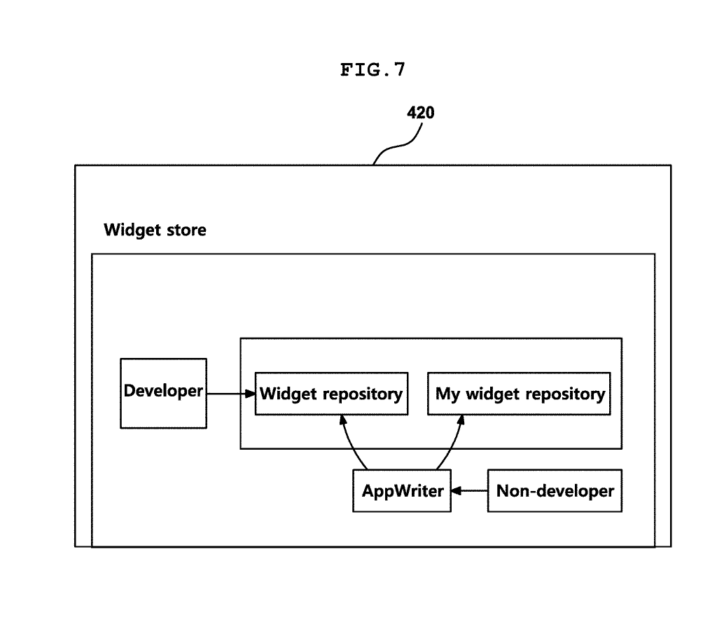

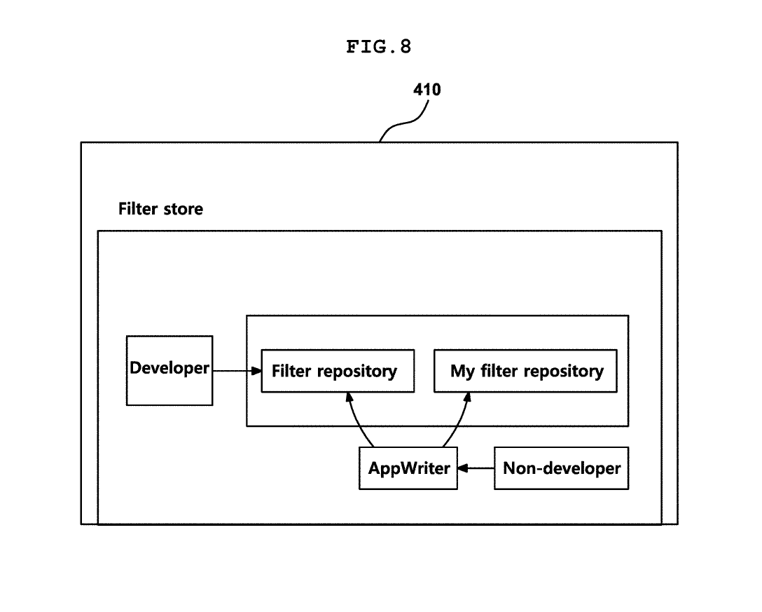

FIG. 1 is a view showing a system configured as a non-developer-oriented application platform according to one or more embodiments of the present invention, FIG. 2 is a view specifically showing a system configured as a non-developer-oriented application platform according to one or more embodiments of the present invention, FIG. 3 is a view showing a driving system of an AppWriter according to one or more embodiments of the present invention, FIG. 4 is a view showing a configuration of a content pipeline according to one or more embodiments of the present invention, FIG. 5 is a view showing a JSON-format app source that is set at the time of generation of an app source according to one or more embodiments of the present invention, FIG. 6 is a view showing a theme store of a resource store according to one or more embodiments of the present invention, FIG. 7 is a view showing a widget store of a resource store according to one or more embodiments of the present invention, and FIG. 8 is a view showing a filter store of a resource store according to one or more embodiments of the present invention.

As shown in FIGS. 1 to 8, a system configured as a non-developer-oriented application platform of one or more embodiments of the present invention includes:

an app's content management unit (application content manager) 100 having a function in which developers register filters in a filter store 110 that deals in a source filter 131, a process filter 132, and a storage filter 133, which process content, a function in which a user who uses a AppWriter 500 uses the registered filters, a function in which the AppWriter 500 provides a method in which a non-developer can configure a content process pipeline without coding, and also provides an N-screen type UI that connects and configures the filters registered in the filter store 110 in the order of necessary processes, a structure which enables the content pipeline 130 dynamically configures a series of procedures of fetching, processing, and storing app content, a function in which content is automatically processed while periodically executing the configured pipeline, and a function in which a general-purpose repository stores various kinds of contents and serves as a content source and repository, and the stored content is used by an app representation unit (application representer) 300;

an app generation unit (application generator) 200 having a function in which a resource store 210 provides various resources necessary for app-writing and operation on a pay-free basis depending on a policy of a resource manufacturer, a function in which the AppWriter 500 provides a WYSIWYG-type UI capable of producing an app that provides a desired function and UI without a prior knowledge for creation of the app, a function in which an app renderer 240 outputs an app source 222 to an UI adapted to a platform, a function in which the content pipeline 230 provides a repository that stores the content created by an app and operates a plurality of repositories as many as necessary;

an app representation unit 300 having a function in which the general-purpose repository 310 configures and manages various repositories capable of storing various kinds of contents, generates and use a repository as many as required by an app, and connects one repository to a number of apps in use, a function in which the app renderer 320 generates an UI to fit the property of a platform called to a region that executes an app source 222 generated by the app generation unit 200 and executed by an app runner, and a function in which a cross-platform app runner provides an API implemented to fit the property of a relevant platform to a cross-platform-based app execution region enabling One Source Multi Use (OSMU), and also provides a runner based on WEB, Android, and iOS; and

an app resource management unit (application resource manager) 400 having a function in which a filter store 410 provides the source filter 131, the process filter 132, and the storage filter 133 that process content, wherein the source filter 131, the process filter 132, and the storage filter 133 are developed by a developer and are provided to a user of the AppWriter 500 on a pay-free basis depending on a policy of a resource manufacturer, a function in which a widget store 420 provides various widgets that use contents or Open API stored in the app content management unit 100 in such that the widgets are provided to the user of the AppWriter 500 and are fabricated as one app, and the filters are provided on a pay-free basis depending on a policy of the resource manufacturer, and also provides a widget manager module and a user module at the time of development of the widget, a function in which a theme store 430 provides a theme for provision of an UI fitting a platform by an app such that the theme is provided for the exclusive use of Web, Android, and iOS or can be developed in a responsive format and provided on a pay-free basis depending on a policy of the resource manufacturer, and a function in which an environment is provided where a non-developer can produce and operate an app using the resource provided by the AppWriter 500.

The function of technical elements constituting the system configured as a non-developer-oriented application platform of one or more embodiments of the present invention will be described hereinafter.

The app's content management unit 100 has a function in which developers register filters in a filter store 110 that deals in a source filter 131, a process filter 132, and a storage filter 133, which process content, a function in which a user who uses a AppWriter 500 uses the registered filters, a function in which the AppWriter 500 provides a method in which a non-developer can configure a content process pipeline without coding, and also provides an N-screen type UI that connects and configures the filters registered in the filter store 110 in the order of necessary processes, a structure which enables the content pipeline 130 dynamically configures a series of procedures of fetching, processing, and storing app content, a function in which content is automatically processed while periodically executing the configured pipeline, and a function in which a general-purpose repository stores various kinds of contents and serves as a content source and repository, and the stored content is used by an app representation unit 300.

The app generation unit 200 has a function in which a resource store 210 provides various resources necessary for app-writing and operation on a pay-free basis depending on a policy of a resource manufacturer, a function in which the AppWriter 500 provides a WYSIWYG-type UI capable of producing an app that provides a desired function and UI without a prior knowledge for creation of the app, a function in which an app renderer 240 outputs an app source 222 to an UI adapted to a platform, a function in which the content pipeline 230 provides a repository that stores the content created by an app and operates a plurality of repositories as many as necessary.

Here, the app configured in the AppWriter 500 constituting the app generation unit 200 is generated as the app source 222 of a JSON format that the app renderer 240 can recognize, and is provided with a sub module registered by developers through stores to produce apps providing various functions.

In addition, the app production in the app generation unit 200 includes: a process of registering a resource in the resource store 210 consisting of the theme store, the widget store, and the filter store; a process of setting a special node using splash, app meta information, theme, header, footer, and menu in order for the AppWriter 500 to generate and edit an app in a mind map type, and a process of setting a content node through presentation layer setting and business logic setting; a process of generating the app source 222 through app preview and source generation; and a process of executing an app using Web, Android, and iOS.

In addition, as shown in FIG. 3, the node setting during the drive of the mind map type AppWriter 500 in the app generation unit 200 includes: a new node adding process of selecting a parent node in consideration of the dependency of a node; a node role setting process of setting each node as a special node or a content node of meta information, theme information, header region, footer region, and menu region, and then setting a module to be applied with respect to the content node, a module setting process in which the content node is generated as many as necessary and is implemented as one page which is configured by a combination of multiple widgets, and a module is set which fits a role designating a method of storing content in a relevant repository by setting the content pipeline when operatively cooperating with the repository, and a parameter setting process in which a widget development company supplies a user widget used by an app and a manager widget 221 used by the AppWriter 500, a selected widget is downloaded from a store through the module setting process, the manager widget 221 is called and activated in the node setting and generates, as a user select value, a parameter necessary during the drive of the user widget through a setting screen provided by itself.

In addition, the setting of the content pipeline 230 in the app generation unit 200 Includes: a process of entering the setting of a pipeline of a content node that can be designated only for the content node, a process of acquiring content from a service supporting the Open API, or fetching the acquired content through the RSS of a blog, a process of designating a repository for storing content by designating an existing general-purpose content repository or a new repository, a process of designating a general-purpose content repository to be used as a repository if content to be used as a general-purpose content bulletin board is not provided externally, a process in which a manufacturing company that developed a filter supplies the filter to AppWriter users through the filter store, and provides information on a filter that can be used in a filter repository selecting a pay-free scheme depending on a policy of the manufacturer at the time of supply of the filter, and a process in which a content crawler as a service externally inquiring content is operated in a predetermined cycle and a content pipeline generated by adding a new content is driven by the crawler in the predetermined cycle.

As shown in FIG. 4, the content pipeline 130 or 230 is configured in the order of the source filter 131 or 231, the process filter 132 or 232, and the storage filter 133 or 233.

In addition, as shown in FIG. 5, the generation of the app source 222 in the app generation unit 200 includes: a process in which each node configured in a mind map type activates a relevant module while setting itself in the vertical dependency relationship and is represented as a format, the app source 222 generated for the content node is used by the content pipeline crawler and the app renderer 240, the setting of each node is converted into the app source 222 of a JSON/XML format through a search from a center of a mind map to a child node, and the generated app source 222 is transferred to the app renderer 240 which turn renders an UI that fits the property of a called platform.

The app representation unit 300 has a function in which the general-purpose repository 310 configures and manages various repositories capable of storing various kinds of contents, generates and use a repository as many as required by an app, and connects one repository to a number of apps in use, a function in which the app renderer 320 generates an UI to fit the property of a platform called to a region that executes an app source 222 generated by the app generation unit 200 and executed by an app runner, and a function in which a cross-platform app runner provides an API implemented to fit the property of a relevant platform to a cross-platform-based app execution region enabling One Source Multi Use (OSMU), and also provides a runner based on WEB, Android, and iOS.

The app resource management unit 400 has a function in which a filter store 410 provides the source filter 131, the process filter 132, and the storage filter 133 that process content, wherein the source filter 131, the process filter 132, and the storage filter 133 are developed by a developer and are provided to a user of the AppWriter 500 on a pay-free basis depending on a policy of a resource manufacturer, a function in which a widget store 420 provides various widgets that use contents or Open API stored in the app content management unit 100 in such that the widgets are provided to the user of the AppWriter 500 and are fabricated as one app, and the filters are provided on a pay-free basis depending on a policy of the resource manufacturer, and also provides a widget manager module and a user module at the time of development of the widget, a function in which a theme store 430 provides a theme for provision of an UI fitting a platform by an app such that the theme is provided for the exclusive use of Web, Android, and iOS or can be developed in a responsive format and provided on a pay-free basis depending on a policy of the resource manufacturer, and a function in which an environment is provided where a non-developer can produce and operate an app using the resource provided by the AppWriter 500.

In addition, as shown in FIG. 6, the theme store in the resource store will be described. A non-developer develops an app in the AppWriter using his or her terminal, stores the developed app in a theme repository and my theme repository, and a designer and a publisher also connect to the theme repository through their terminals.

In addition, as shown in FIG. 7, the widget store in the resource store will be described. A non-developer develops an app in the AppWriter using his or her terminal, stores the developed app in a widget repository and my widget repository, and a developer also connect to the widget repository through his or her terminals.

In addition, as shown in FIG. 8, the filter store in the resource store will be described. A non-developer develops an app in the AppWriter using his or her terminal, stores the developed app in a filter repository and my filter repository, and a developer also connect to the filter repository through his or her terminals.

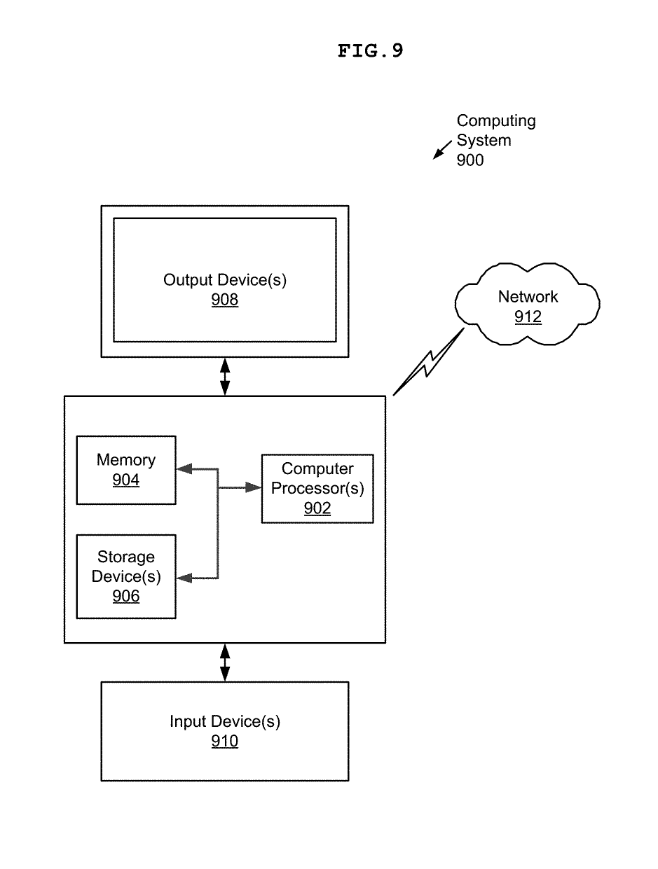

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 9, the computing system (900) may include one or more computer processor(s) (902), associated memory (904) (e.g., random access memory (RAM), cache memory, flash memory, etc.), one or more storage device(s) (906) (e.g., a hard disk, an optical drive such as a compact disk (CD) drive or digital versatile disk (DVD) drive, a flash memory stick, etc.), and numerous other elements and functionalities. The computer processor(s) (902) may be an integrated circuit for processing instructions. For example, the computer processor(s) may be one or more cores, or micro-cores of a processor. The computing system (900) may also include one or more input device(s) (910), such as a touchscreen, keyboard, mouse, microphone, touchpad, electronic pen, or any other type of input device. Further, the computing system (900) may include one or more output device(s) (908), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (900) may be connected to a network (912) (e.g., a local area network (LAN), a wide area network (WAN) such as the Internet, mobile network, or any other type of network) via a network interface connection (not shown). The input and output device(s) may be locally or remotely (e.g., via the network (912)) connected to the computer processor(s) (902), memory (904), and storage device(s) (906). Many different types of computing systems exist, and the aforementioned input and output device(s) may take other forms.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

As described above, the system configured as a non-developer-oriented application platform of one or more embodiments of the present invention as described above can be widely applied in a field that provides a fabrication method necessary when a non-developer develops an application.

What is claimed is:

1. A system constituting a non-developer-oriented application platform, the system comprising:
an application content manager that:
causes developers to register filters in a filter store that deals in a source filter, a process filter, and a storage filter that process a content;
enables a user who uses an AppWriter to use the registered filters;
causes the AppWriter to provide a method in which a non-developer can configure a content process pipeline without coding;
automatically processes the content while periodically executing the configured pipeline; and
causes a general-purpose repository to store different kinds of contents and serve as a content source and repository,
an application generator that:
causes a resource store to provide resources necessary for app-writing and operation;
causes the AppWriter to provide a WYSIWYG-type UI capable of producing an application that provides a desired function and UI without a prior knowledge for creation of the application;
causes an application renderer to output an application source to an UI adapted to the platform; and
causes the content pipeline to provide a repository that stores the content created by an application and operate a plurality of repositories,
an application representer that:
causes the general-purpose repository to manage repositories capable of storing different kinds of contents, generate and use a repository required by an application, and connect one repository to a number of applications in use; and
causes the application renderer to generate an UI to fit the property of the platform called to a region that executes an application source generated by the application generator and executed by an application runner, and
an application resource manager that:
causes a filter store to provide the source filter, the process filter, and the storage filter that process the content, wherein the source filter, the process filter, and the storage filter are developed by a developer and are provided to a user of the AppWriter;
causes a widget store to provide widgets that use the contents or Open API stored in the application content manager, wherein the widgets are provided to the user of the AppWriter and are fabricated as one application, and also provide a widget manager module and a user module at the time of development of the widget;
causes a theme store to provide a theme for provision of an UI fitting the platform by an application, wherein the theme is provided for the exclusive use of Web, Android, and iOS or can be developed in a responsive format; and
provides an environment where a non-developer can produce and operate an application using the resource provided by the AppWriter.

2. The system constituting a non-developer-oriented application platform according to claim 1, wherein the application configured in the AppWriter constituting the application generator is generated as the application source of a JSON format that the application renderer can recognize, and is provided with a sub module registered by the developers through the stores to produce applications providing a plurality of functions.

3. The system constituting a non-developer-oriented application platform according to claim 1, wherein the application production in the application generator comprises:
a process of registering a resource in the resource store consisting of the theme store, the widget store, and the filter store;
a process of setting a special node using splash, application meta information, theme, header, footer, and menu in order for the AppWriter to generate and edit an application in a mind map type;
a process of setting a content node through presentation layer setting and business logic setting;
a process of generating the application source through application preview and source generation; and
a process of executing an application using Web, Android, and iOS.

4. The system constituting a non-developer-oriented application platform according to claim 3, wherein the node setting during the drive of the mind map type AppWriter in the application generator comprises:
a new node adding process of selecting a parent node in consideration of the dependency of each node;
a node role setting process of setting each node as a special node or a content node of meta information, theme information, header region, footer region, and menu region, and then setting a module to be applied with respect to the content node,
a module setting process of generating the content node and implementing the content node as one page constituted by a combination of multiple widgets, and setting a module that fits a role designating a method of storing the content in a relevant repository by setting the content pipeline when operatively cooperating with the repository, and
a parameter setting process of causing a widget development company to supply a user widget used by an application and a manager widget used by the AppWriter, wherein a selected widget is downloaded from the store through the module setting process, and the manager widget is called and activated in the node setting and generates, as a user select value, a parameter necessary during the drive of the user widget through a setting screen provided by the manager widget.

5. The system constituting a non-developer-oriented application platform according to claim 1, wherein the setting of the content pipeline in the application generator comprises:
a process of entering setting of a pipeline of a content node that can be designated only for the content node,
a process of acquiring the content from a service supporting the Open API, or fetching the acquired content through the RSS of a blog,
a process of designating a repository for storing the content by designating an existing general-purpose content repository or a new repository,
a process of designating a general-purpose content repository to be used as a repository if the content to be used as a general-purpose content bulletin board is not provided externally,
a process of causing a manufacturing company that developed a filter to supply the filter to AppWriter users through the filter store, and provide information on a filter that can be used in a filter repository selecting a pay-free scheme depending on a policy of the manufacturer at the time of supply of the filter, and
a process of causing a content crawler as a service externally inquiring the content to operate in a predetermined cycle and driving a content pipeline generated by adding a new content by the crawler in the predetermined cycle.

6. The system constituting a non-developer-oriented application platform according to claim 1, wherein the content pipeline is configured in the order of the source filter, the process filter, and the storage filter.

7. The system constituting a non-developer-oriented application platform according to claim 1, wherein the generation of the application source in the application generator comprises:
a process of causing each node configured in a mind map type to activate a relevant module while setting the node in the vertical dependency relationship and is represented as a format, wherein the application source generated for the content node is used by the content pipeline crawler and the application renderer, the setting of each node is converted into the application source of a JSON/XML format through a search from a center of a mind map to a child node, and the generated application source is transferred to the application renderer that renders an UI that fits the property of a called platform.

8. The system constituting a non-developer-oriented application platform according to claim 1, wherein the application content manager provides an N-screen type UI that connects the filters registered in the filter store in the order of necessary processes, and has a structure that enables the content pipeline dynamically configures a series of procedures of fetching, processing, and storing application content.

9. The system constituting a non-developer-oriented application platform according to claim 1, wherein the application representer causes a cross-platform application runner to provide an API implemented to fit the property of a relevant platform to a cross-platform-based application execution region enabling One Source Multi Use (OSMU), and provides a runner based on WEB, Android, and iOS.
